(19) United States
(12) Patent Application Publication
(10) Pub. No.: US 2006/0117132 A1
(43) Pub. Date: Jun. 1, 2006

(54) Self-configuration and automatic disk balancing of network attached storage devices

(75) Inventors: James Christopher Gray, Bellevue, WA (US); Sergey Solyanik, Seattle, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/999,731

(22) Filed: Nov. 30, 2004

(51) Int. Cl. G06F 12/14

(52) U.S. Cl. 711/100

(57) ABSTRACT

Systems and methods for self-configuration and automatic disk balancing of network attached storage devices are disclosed. Methods are disclosed for providing automatic disk balancing that uses a self-configuring set of network storage devices. A self-configuring set of network storage devices enables a user to merely plug in a new storage device; the network self-configures to provide additional storage. The user, as well as applications available on the client computer, can then logically access data stored on any of a plurality of such devices as if the data were stored on a single selected one of the devices.

### FIELD OF THE INVENTION

The invention relates generally to network attached storage devices. More particularly, the invention relates to self-configuration and automatic disk balancing of network attached storage devices.

### BACKGROUND OF THE INVENTION

A network attached storage (NAS) device may be used to store data such as audio or video files, photographs, web pages, documents, etc. Over time, such a storage device may approach its storage capacity (i.e., it may become full). When this occurs, a user typically must either delete data from the storage device to free storage space or add more storage devices onto the network.

In corporate networking environments, where the storage devices are typically file servers, a system administrator with detailed knowledge of the network and networking technology is usually required to manually reconfigure the network to enable clients on the network to access a newly added storage device. For example, a user of a client on the network may be allocated storage space on a first storage device. As the first storage device approaches its storage capacity, the system administrator may elect to add a second storage device to the network. After the addition of the second storage device, files may be stored physically on either storage device. Similarly, the client may access files (e.g., open, copy, delete, etc.) on either storage device.

The user, however, typically does not want to be burdened with choosing between two storage devices in order to store a new data file, nor with searching two storage devices to find a previously stored file. Typically, the user would prefer to be able to logically store the file to a designated storage device, regardless of where the file is physically stored. Similarly, the user would like to be able to logically access the file on the designated storage device, regardless of where the file is physically stored. That is, it would be desirable if the addition of a second storage device were transparent from the user's perspective, so that the user could logically access the designated server, even where the data being accessed is physically stored on a different server.

In a corporate networking environment, the system administrator could use the well-known “distributed file system” (DFS) to group the several file servers in a way that they appear to the client as one server. Consequently, if a client attempts to logically access, via a designated server, data that is physically stored on another server, the client will be automatically redirected to the other server.

To satisfy the demand for increased storage capacity on home networks, home network users are likely to add more and more NASs to their home networks. The typical home network user, however, lacks the detailed knowledge of networks and networking technology that a system administrator in a corporate environment is required to possess in order to manually reconfigure a network using DFS. It would be desirable, therefore, if a methodology were available whereby a home network could be automatically reconfigured upon the addition of a new network attached storage device so that files stored physically on different storage devices could be accessed logically as if they were stored on a single device.

### SUMMARY OF THE INVENTION

The invention provides systems and methods for self-configuration of network attached storage devices (NASs), and for automatic disk balancing of data stored across a plurality of NASs. Well-known tools such as universal plug-and-play (UPnP), server message block (SMB), and distributed file system (DFS), for example, may be employed. By using DFS, it is possible to group servers in a way that they appear to a user as one. According to an aspect of the invention, the storage devices may configure one another, using UPnP, for example, so that no configuration by the user is required.

Thus, the invention may enable a user to merely plug in a new storage device; the network self-configures to provide additional storage. The user, as well as applications available on the client computer, may then logically access data stored on any of a plurality of such devices as if it were stored on a single selected one of the devices.

### BRIEF DESCRIPTION OF THE DRAWINGS

The foregoing summary, as well as the following detailed description of illustrative embodiments, is better understood when read in conjunction with the appended drawings. For the purpose of illustrating the invention, there are shown in the drawings example embodiments of the invention. It should be understood, however, that the invention is not limited to the specific embodiments disclosed.

FIG. 1 is a block diagram showing an example computing environment in which aspects of the invention may be implemented.

FIG. 2 depicts an example embodiment of a system for self-configuration and automatic disk-balancing in accordance with the invention.

FIG. 3 is a flow chart of a self-configuration and automatic disk-balancing protocol according to the invention.

FIGS. 4A and 4B depict example directory structures in, respectively, a prior art system and a system according to the invention.

### DETAILED DESCRIPTION OF ILLUSTRATIVE EMBODIMENTS

Example Computing Environment

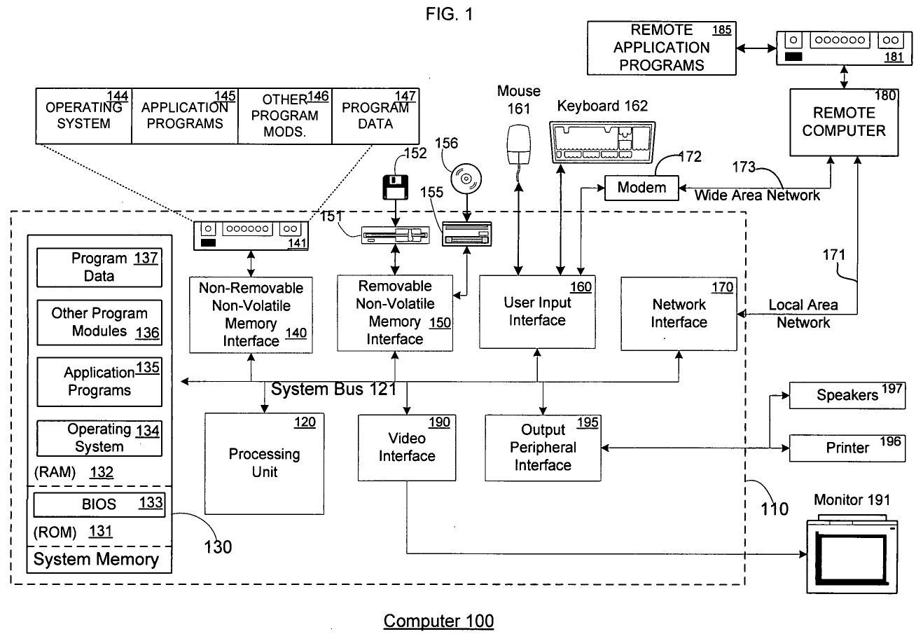

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Self-Configuration and Automatic Disk Balancing of Network-Attached Storage Devices

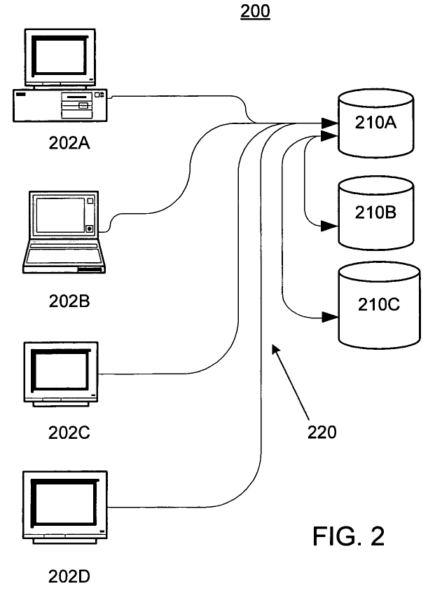

FIG. 2 depicts an example embodiment of a system 200 for self-configuration and automatic disk-balancing in accordance with the invention. As shown, one or more host devices 202A-D may be coupled to a network 220, which may be a home network for example. The host devices 202A-D may be, for example, desktop or laptop computers, televisions, set-top boxes, etc. One or more network-attached storage (NAS) devices 210A-C may also be coupled to the network 220.

A network-attached storage device may be set up with its own network address rather than being attached to a central computer that is serving applications to a network's workstation users. A network-attached storage device may be attached to a local area network (typically, an Ethernet network) and assigned an IP address. File requests may be mapped by the main server to the NAS file server.

A network-attached storage device may include hard disk storage, such as multi-disk RAID systems, for example, and software for configuring and mapping file locations to the network-attached storage device. NAS software can usually handle a number of network protocols, including Microsoft's Internetwork Packet Exchange, Novell's Netware Internetwork Packet Exchange NetBEUI, and Sun Microsystems's Network File System. A Web browser may be used for configuration of the device, including the setting of user access priorities. Network-attached storage may be a step toward, and included as part of, a more sophisticated storage system known as a storage area network (SAN).

Generally, a system 200 according to the invention may operate as follows. A first storage device, say 210A, may be connected onto the network 220. One or more of the host devices 202A-D may then use the storage device 210A for data storage. The host devices 202A-D may continue to add data until the storage device 210A is out of storage. If the storage device 210A runs out of storage, the user may be required to decide which data must be deleted from the storage device 210A to make room for new data. According to the invention, however, a few existing technologies may be combined in such a way that the user need do nothing more than plug an additional storage device, say 210B, into the network 220. Thus, in a system according to the invention, the user may be enabled to choose between deleting data on a first storage device 210A or adding a second storage device 210B to make room for new data.

In an example embodiment of the invention, when a first storage device is connected into the network it may be configured to assume the role of a UPnP device. It may announce its presence to any other UPnP-enabled devices on the network. When a second storage device is connected into the network it may automatically be configured to assume the role of a UPnP control point. It may then communicate its available specifications (e.g., disk speed, performance, etc.) to the first storage device so appropriate load-leveling algorithms can be employed.

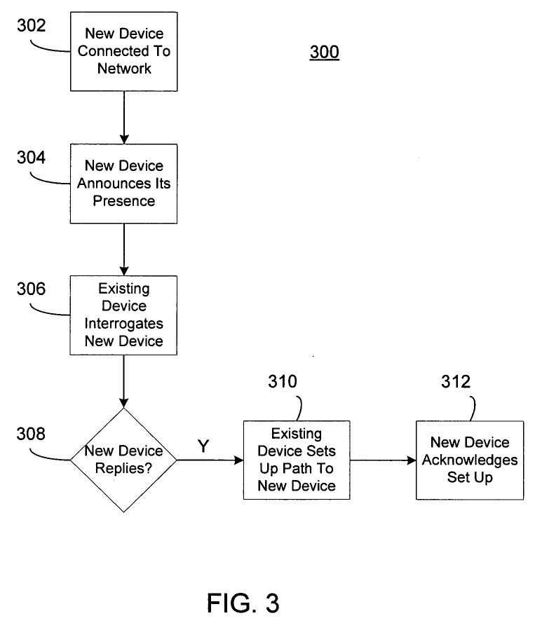

A new storage device may be connected into the network according to a protocol 300 such as depicted in the flowchart shown in FIG. 3. At 302, the new storage device may be connected into the network, via an Ethernet connection, for example. The new storage device may detect the Ethernet connection and thus detect that it has been connected into a network.

At 304, the new storage device, after having detected that it has been connected into a network, may announce its presence on the network, using UPnp or GINI, for example. The new device may, for example, broadcast a message onto the network. The message may inform any other device on the network that can receive and interpret the message that the new device has been connected into the network. The message may also indicate a device type associated with the new device. For example, the message may indicate that the new device is an NAS.

At 306, any other device on the network that is programmed to care about the fact that a new device of the specified type has arrived, interrogates the new device. If no device interrogates the new device after it broadcasts its arrival message, then the new device assumes that it is the first of its kind on the network. For example, if the new device is an NAS, and no other device responds when the new NAS announces its presence on the network, then the new NAS assumes that it is the first NAS on the network.

If a first NAS is already connected to the network, and the new device is an additional NAS, then the first NAS may interrogate the new NAS to determine, for example, whether the new NAS supports a disk-balancing system according to the invention. In other words, the first NAS may determine whether continuing to exercise the protocol 300 will be meaningful to the new NAS.

At 308, the newly added device replies to the interrogation by telling the original NAS whether or not it supports the protocol associated with a disk-balancing system according to the invention. Silence may be interpreted by the existing device as indicating that the newly added device does not support the protocol.

If, at 308, the newly added NAS indicates that it supports the disk-balancing protocol, then, at 310, the original NAS sets up a path to the new NAS. For example, the original NAS could inform the new NAS that the original NAS and the new NAS are to operate in a client-server relationship, where the original NAS is the server and the new NAS is the client. The original NAS may assign a name and/or password to the new NAS. The original NAS may inform the new NAS that it is going to share its disk with any of one or more files. Thus, user can start using the new NAS without being required to set up a file structure or a password.

At 312, the new NAS acknowledges to the existing device that the new device has received and understands the set-up information provided by the existing device.

Typically, when a new storage device comes online, it will be because the existing storage device is nearing its storage capacity. The new storage device, however, will be at zero capacity (i.e., nothing has yet been stored on the newly added storage device). According to an aspect of the invention, the system may attempt to balance the used file space between the devices in such a way that the user is unaware that two devices are involved with their file transfer. Any number of well-known algorithms may be used for this purpose. For example, DFS technology within SMB file sharing may be used.

Folders may be automatically distributed among the two devices, either as data is being generated or as part of a maintenance task. For example, the following folder structure may appear to the user before the addition of second NAS:

\\NAS1\share1\Music\rock→NAS device 1

\\NAS1\share1\\Music\Country→NAS device 1,

where files that are logically stored in the folder to the left of the → are physically stored in the device to the right of the →.

After the addition of the second NAS, the following folder structure may appear to the user:

\\NAS1\share1\Music\Rock→NAS device 1

\\NAS1\share1\Music\Country→NAS device 2.

In this example, files that were stored in the folder “\share1\Music\Country” on NAS1 before the addition of NAS2 may be automatically redirected to a folder “\share1\Music\Country” on NAS2. To the network device (and to the user of the network device), however, the files appear logically to be stored in the same folders on the same device as before. Thus, stored data may be automatically redirected to a new NAS device that has available storage capacity, without the need for the user to change the server name in the user's client software.

According to another aspect of the invention, an existing NAS may use DFS to mount a newly added NAS on a new folder. The new folder may refer to data stored physically on the newly added device. Applications running on the host computer, such as Windows Explorer, Windows Media Player, for example, as well as the user of the host computer, may perceive this logically as if the data were stored on a single one of the storage devices.

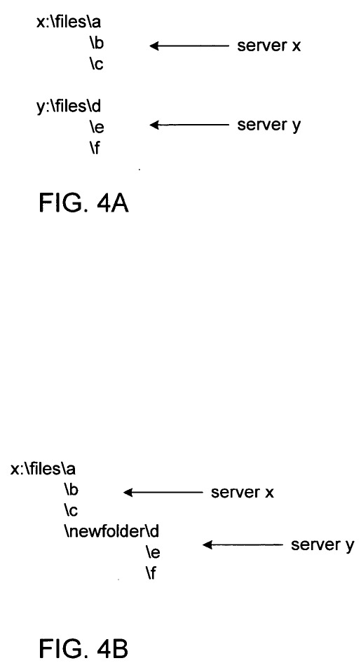

FIG. 4A depicts a prior art directory structure for storing files across a plurality of network attached storage devices. As shown in FIG. 4A, a first storage device, x, may include a directory “\files.” The “\files” directory may include one or more sub-directories “\a,” “\b,” and “\c,” for example. A second storage device, y, may include a directory “\files.” The “\files” directory on device y may include one or more sub-directories “\d,” “\e,” and “\f,” for example.

To the user of a network device, as well as to programs that might be running on the network device, the storage devices appear as separate devices. In order to write data to a particular directory, the user must know which directory he wants to write to and navigate to that directory. To retrieve data previously written, the user must know where the file is stored, and navigate to that directory. Programs, such as Windows Explorer, for example, must also logically treat the data as if it is physically stored on separate devices.

FIG. 4B depicts a directory structure according to the invention for storing files across a plurality of network attached storage devices. As shown in FIG. 4B, a first storage device, x, may include a directory “\files.” The “\files” directory may include one or more sub-directories “\a,” “\b,” and “\c,” for example. The storage device x may include a directory “\newfolder” that includes one or more sub-directories “\d,” “\e,” and “\f,” for example. Files stored physically on a second storage device, say device y, may be accessed logically by accessing “x:\files\newfolder\.”

Before the addition of the second NAS (e.g., device y), the user can write to x:\files\a, \b, and \c. After addition of device y, the user can also write to x:\files\newfolder\d, \e, and \f. The device x understands that a reference to x:\files\newfolder is a reference to something stored on, or to be written to, device y. The device x automatically redirects the data from the device y to the host computer, or from the host computer to the device y. The device x can redirect the data either through the device x or directly via the network to the device y. Accordingly, the storage devices may be coupled to one another via the network so that they can communicate with each other and transfer data between themselves.

Like the user, applications programs, such as Windows Explorer, for example, logically see only one server, even though there may be more than one physical server. Accordingly, a user or program can search through one server logically, even though it is really searching through more than one.

Though the present invention has been described in connection with the preferred embodiments of the various figures, it is to be understood that other embodiments may be used or modifications and additions may be made to the described embodiments for performing the same function of the present invention without deviating therefrom. In no way is the present invention limited to the examples provided herein. Therefore, the present invention should not be limited to any single embodiment, but rather should be construed in breadth and scope in accordance with the appended claims.

What is claimed:

1. A method for configuring a network attached storage device, the method comprising:
detecting that a first storage device has been connected onto a network;
broadcasting onto the network that the first storage device has been connected;
determining whether a second storage device is connected onto the network; and
receiving configuration information from the second storage device.

2. The method of claim 1, further comprising:
receiving an interrogation message from the second storage device; and
providing to the second storage device an indication that the first storage device is adapted to be configured by the second storage device.

3. The method of claim 1, wherein the configuration information defines a data path to the second storage device from a host computer that is also connected onto the network.

4. The method of claim 3, further comprising:
receiving data from the host computer.

5. The method of claim 4, wherein the host computer has been instructed by the first storage device to redirect data to the second storage device.

6. The method of claim 4, wherein the data is a data file.

7. The method of claim 1, further comprising:
receiving data from the first storage device.

8. The method of claim 1, further comprising:
receiving data from the first storage device to balance available storage capacity between the first storage device and the second storage device.

9. The method of claim 1, wherein the connection is an Ethernet connection.

10. A method for configuring a network attached storage device, the method comprising:
receiving a message indicating that a first storage device has been connected onto a network;
sending an interrogation message to the first storage device to determine whether the first storage device is adapted to be configured by a second storage device;
receiving an indication that the first storage device is adapted to be configured by the second storage device; and
providing configuration information to the first storage device.

11. The method of claim 10, wherein the configuration information defines a data path to the second storage device from a host computer that is also connected onto the network.

12. The method of claim 11, further comprising:
instructing the host computer to redirect data to the first storage device.

13. The method of claim 12, wherein the data is a data file.

14. The method of claim 11, further comprising:
providing data to the first storage device.

15. The method of claim 11, further comprising:
receiving data from the first storage device to balance available storage capacity between the first storage device and the second storage device.

16. A storage device, comprising:
means for coupling the storage device to a network; and
a computer-readable medium having stored thereon computer-executable instructions for performing a method comprising:
detecting that a first storage device has been connected onto a network;
broadcasting onto the network that the first storage device has been connected;
determining whether a second storage device is connected onto the network; and
receiving configuration information from the second storage device.

17. A storage device, comprising:
means for coupling the storage device to a network; and
a computer-readable medium having stored thereon computer-executable instructions for performing a method comprising:
receiving a message indicating that a first storage device has been connected onto a network;
sending an interrogation message to the first storage device to determine whether the first storage device is adapted to be configured by a second storage device;
receiving an indication that the first storage device is adapted to be configured by the second storage device; and
providing configuration information to the first storage device.

18. A computer-readable medium having stored thereon a directory structure comprising:
a first directory associated with a first network attached storage device; and
a second directory associated with a second network attached storage device,
wherein the first and second directories provide logical access to a single one of the network attached storage devices, and physical access to both of the network attached storage devices.

19. The computer-readable medium of claim 18, wherein the first directory includes a reference to a first file that is physically stored on the first network attached storage device and the second directory includes a reference to a second file that is physically stored on the second network attached storage device.

20. The computer-readable medium of claim 18, having stored thereon an applications program adapted to access files stored physically on the storage devices by logically accessing only a singe one of the storage devices.
